(19) United States
(12) Patent Application Publication
(10) Pub. No.: US 2010/0142584 A1
(43) Pub. Date: Jun. 10, 2010

(54) DIGITAL LINEAR HEAT DETECTOR WITH THERMAL ACTIVATION CONFIRMATION

(76) Inventors: Brian P. Harrington, Plymouth, MA (US); Gary P. Fields, Marshfield, MA (US)

Correspondence Address: CESARI AND MCKENNA, LLP, 88 BLACK FALCON AVENUE, BOSTON, MA, 02210, US

(21) Appl. No.: 12/331,093

(22) Filed: Dec. 9, 2008

(51) Int. Cl. G01N 25/20

(52) U.S. Cl. 374/43; 374/E07.001

(57) ABSTRACT

The present invention provides a digital linear heat detector with thermal activation confirmation. In operation, a run of the digital linear heat detector with thermal activation confirmation may be made throughout a building and operatively interconnected with a monitoring circuit. Opposite the monitoring circuit at the end of the length of digital linear heat detector with thermal activation confirmation is a resistor that terminates the digital linear heat detector with thermal activation confirmation. A digital linear heat detector with thermal activation confirmation comprises a pair of spring conductors. At least one of which is coated with a thermoplastic NTC material and at least one of which is coated with a non-conductive heat sensitive material. One or both of the conductors may be coated with both the NTC material and the non-conductive heat sensitive material in alternative embodiments of the present invention.

### FIELD OF THE INVENTION

The present invention relates to a linear heat detection systems and, more particularly to a digital linear heat detector with thermal activation confirmation.

### BACKGROUND OF THE INVENTION

Remote temperature sensing systems are known in the art for the remote detection of overheated regions that may be utilized in, for example, fire detection and suppression systems, etc. One common type of remote temperature sensing system is a linear heat detector. There are a number of different types of linear heat detectors currently available including, for example, digital linear heat detectors and analog linear heat detectors.

Digital linear heat detectors are well-known in the art including, for example, U.S. Pat. No. 2,185,944 entitled FIRE-DETECTING CABLE by Willis Holmes, issued Jan. 2, 1940, the contents of which are hereby incorporated by reference. Generally, a digital linear heat detector comprises a pair of spring conductors that are coated with a special heat sensitive polymer that melts at a specific temperature. The two conductors are then twisted together to maintain a substantially continuous spring pressure between the conductors. Typically, the twisted pair of conductors are then wrapped in a protective Mylar® tape, before an outer jacket is extruded over the taped pair.

FIG. 1A is an exemplary digital linear heat detector environment 100A illustrating a typical digital linear heat detector installation. A monitoring circuit 105 is operatively interconnected with a run of a digital linear heat detector 110, which is terminated by a resistor 115. The monitoring circuit 105 maintains a current flow through the digital linear heat detector 110 to the terminating resistor 115, which regulates the current flow through the digital linear heat detector. When current is flowing through the digital linear heat detector at a known level, the monitoring circuit 105 indicates that the system is in a NORMAL state.

FIG. 1B is an exemplary digital linear heat detector environment 100B showing an open circuit 120 caused by a break in digital linear heat detector. In a situation as shown in environment 100B, the monitoring circuit 105 detects that the current flow has stopped, which causes the monitoring circuit 105 to move to a TROUBLE state. Typically, the monitoring circuit 105 may sound an alarm or alert an administrator that the detection capabilities of the system are compromised and that action needs to be taken to restore temperature detection functionality.

FIG. 1C is an exemplary digital linear heat detector environment 100C illustrating operation in the presence of a fire 125 or other significant heat source. Illustratively, the fire 125 raises the temperature higher than the melting point of the special heat sensitive polymer, thereby causing a short circuit by enabling the two conductors to come into contact with each other. This results in an increase in the current through the digital linear heat detector due to the terminating resistor 115 being bypassed. In response, the monitoring circuit 105 will indicate this as an ALARM condition and take appropriate action, e.g., activation of fire suppression systems, etc. However, this leads to a noted disadvantage of digital linear heat detectors. Should the digital linear heat detector be physically damaged, thereby causing a short condition, the monitoring circuit 105 will move to an ALARM state with concomitant activation of fire suppression systems. As will be appreciated by one skilled in the art, activation of fire suppression systems in the absence of a fire may result in water damage to a building, goods being stored therein, potential injury to occupants, etc.

Typical digital linear heat detectors 110 have a known impedance, e.g., 0.2 Ohms per foot. Thus, during an ALARM state, the resistance along the digital linear heat detector may be measured to determine the location of the fire.

As noted above, a second type of linear heat detector is an analog linear heat detector. Analog linear heat detectors typically use a negative temperature coefficient (NTC) material that covers two or more conductors to detect temperature changes. Examples of NTC insulators include, e.g., conductive PVC. The resistance of the NTC material decreases as the temperature increases. This change in resistance is integrated along the entire length of the analog linear heat detector.

FIG. 2 is a schematic diagram of an exemplary model of an analog linear heat detector 200. Illustratively, analog linear heat detectors may be modeled as a large group of resistors in parallel. A proprietary interface 205 is connected to the conductors of the analog linear heat detector 210 and 215. The current flow through each resistor 220 increases with temperature. Due to this integrative effect, small ambient temperature changes may have the same effect as a large localized temperature change, thereby limiting the ability to determine the detector cross section exposed to the heat event or the true temperature of that cross section. This provides several limitations on installation lengths of analog linear heat detectors as small changes in the ambient temperature along a long installation length may be integrated to cause an ALARM condition. Furthermore, due to the integrative effect, analog linear heat detectors cannot and/or are limited in the ability to determine where a fire condition occurs along the installation length.

Certain recent improvements to a linear heat detectors, such as that described in United States Patent Publication No. US2008/0084268A1, by Weishe Zhang, et al, published Apr. 10, 2008, the contents of which are hereby incorporated by reference, improve on some of the noted disadvantages of digital linear heat detectors. The Zhang published application details a digital linear heat detector that works to prevent short circuits from causing an ALARM condition. However, a noted disadvantage exists that the Zhang linear heat detector cannot provide positive determination that a thermal event, i.e., an overheat condition, caused the ALARM condition.

### SUMMARY OF THE INVENTION

The present invention overcomes the disadvantages of the prior art by providing a digital linear heat detector with thermal activation confirmation that includes the advantages of both analog and digital linear heat detectors while eliminating disadvantages of both types of linear heat detectors. In operation, a length of the detector may be made throughout a building and operatively interconnected with a monitoring circuit. The length of detector loops back to the monitoring circuit or the end of the length of detector may be terminated by a resistor.

Illustratively, the novel linear heat detector of the present invention comprises a pair of spring conductors. At least one of which is coated with a conductive thermoplastic NTC material and at least one of which is coated with a non-conductive heat sensitive material. One or both of the conductors may be coated with both the NTC material and the non-conductive heat sensitive material in alternative embodiments of the present invention. Furthermore, the layering of the NTC material and the non-conductive heat sensitive material may vary in alternative embodiments of the present invention. The coated conductors are then twisted together to form a substantially continuous spring pressure between the two conductors.

Notably, the heat detector of the present invention provides several advantages over prior art digital and/or analog linear heat detectors. The novel heat detector does not generate ALARM states when a mechanical short occurs. Furthermore, a secondary alarm state can be defined by the NTC conductive curve of the detector. Thus, they offer an improvement over conventional digital linear heat detectors. As such, the digital linear heat detector with thermal activation confirmation of the present invention provides a fixed temperature activation that is unaffected by changes in ambient temperature, i.e., they do not have the integrative problem associated with analog linear heat detectors.

### BRIEF DESCRIPTION OF THE DRAWINGS

The above and further advantages of the invention may be better understood by referring to the following description in conjunction with the accompanying drawings in which like reference numerals indicate identical or functionally similar elements:

FIG. 1A, previously described is a schematic block diagram of an exemplary digital linear heat detector environment;

FIG. 1B, previously described, is a schematic block diagram of an exemplary digital linear heat detector environment illustrating an open circuit;

FIG. 1C, previously described, is a schematic block diagram of an exemplary digital linear heat detector illustrating detection of a fire;

FIG. 2, previously described, is a schematic diagram of an exemplary model of an analog linear heat detector;

FIG. 3A is a schematic block diagram of an exemplary digital linear heat detector with thermal activation confirmation environment in accordance with an illustrative embodiment of the present invention;

FIG. 3B. is a schematic block diagram of an exemplary digital linear heat detector with thermal activation confirmation environment without a terminating resistor in accordance with an illustrative embodiment of the present invention;

FIG. 3C is a schematic block diagram of an exemplary hybrid linear detector environment illustrating an open circuit in accordance with an illustrative embodiment of the present invention;

FIG. 3D is a schematic block diagram of an exemplary linear heat detector environment illustrating overheat (e.g., fire) detection in accordance with an illustrative embodiment of the present invention;

FIG. 4 is a flowchart detailing the steps of a procedure for over heat detection in accordance with an illustrative embodiment of the present invention;

FIG. 5 is a graph illustrating an exemplary NTC curve showing changes in resistance as an over heat condition progresses in accordance with an illustrative embodiment of the present invention;

FIG. 6 is a schematic diagram of an exemplary cross-section of a digital linear heat detector with thermal activation confirmation in accordance with an illustrative embodiment of the present invention;

FIG. 7 is a schematic diagram of an exemplary cross-section of any digital linear heat detector with thermal activation confirmation in accordance with an illustrative embodiment of the present invention;

FIG. 8 is a schematic diagram of an exemplary cross-section of a digital linear heat detector with thermal activation confirmation in accordance with an illustrative embodiment of the present invention;

FIG. 9 is a schematic diagram of an exemplary cross-section of a digital linear heat detector with thermal activation confirmation in accordance with an illustrative embodiment of the present invention;

FIG. 10 is a schematic diagram of an exemplary cross section of a digital linear heat detector with thermal activation confirmation in accordance with an illustrative embodiment of the present invention;

FIG. 11 is a schematic diagram of an exemplary cross-section of a digital linear heat detector with thermal activation confirmation in accordance with an illustrative embodiment of the present invention;

FIG. 12 is a schematic diagram of an exemplary cross-section of a digital linear heat detector with thermal activation confirmation in accordance with an illustrative embodiment of the present invention.

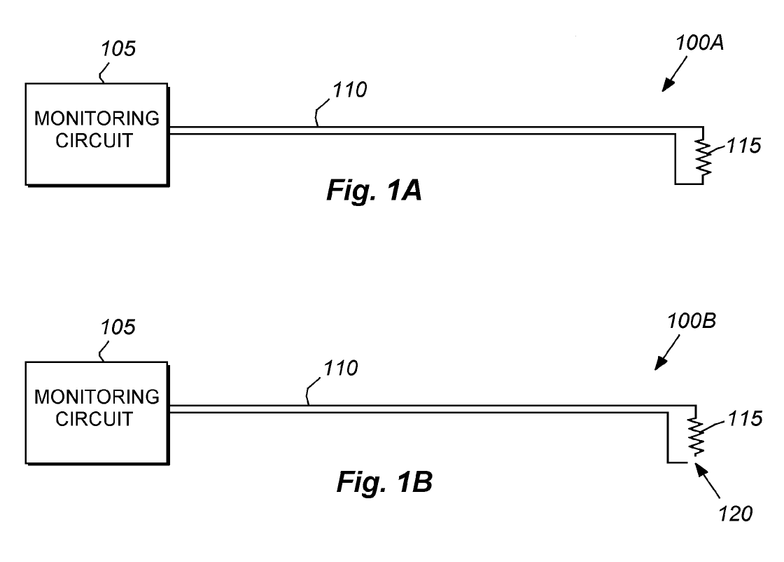

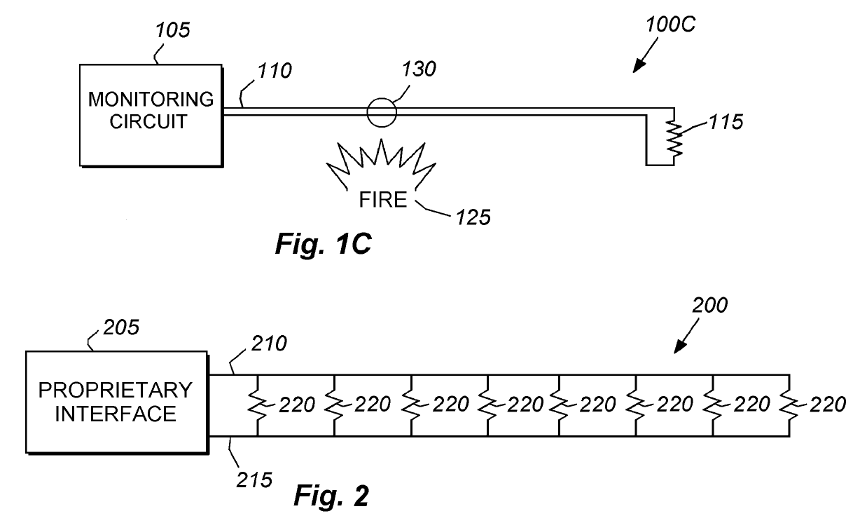

### DETAILED DESCRIPTION OF AN ILLUSTRATIVE EMBODIMENT

The present invention provides a digital linear heat detector with thermal activation confirmation that includes the advantages of both analog and digital linear heat detectors while eliminating disadvantages of both types of linear heat detectors. In operation, a length of the detector may be made throughout a building and operatively interconnected with a monitoring circuit. The length of detector loops back to the monitoring circuit or the end of the length of the detector may be terminated by a resistor.

Illustratively, the novel linear heat detector of the present invention comprises a pair of spring conductors. At least one of which is coated with a conductive thermoplastic NTC material and at least one of which is coated with a non-conductive heat sensitive material. One or both of the conductors may be coated with both the NTC material and the non-conductive heat sensitive material in alternative embodiments of the present invention. Furthermore, the layering of the NTC material and the non-conductive heat sensitive material may vary in alternative embodiments of the present invention. The coated conductors are then twisted together to form a substantially continuous spring pressure between the two conductors.

Notably, the heat detector of the present invention provides several advantages over prior art digital and/or analog linear heat detectors. The novel heat detector does not generate ALARM states when a mechanical short occurs. Furthermore, a secondary alarm state can be defined by the NTC conductive curve of the detector. Thus, they offer an improvement over conventional digital linear heat detectors. As such, the digital linear heat detector with thermal activation confirmation of the present invention provides a fixed temperature activation that is unaffected by changes in ambient temperature, i.e., they do not have the integrative problem associated with analog linear heat detectors.

A. Digital Linear Heat Detector Environment

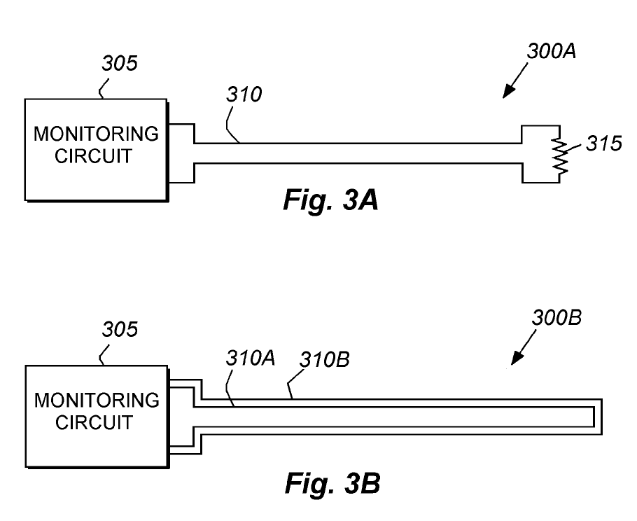

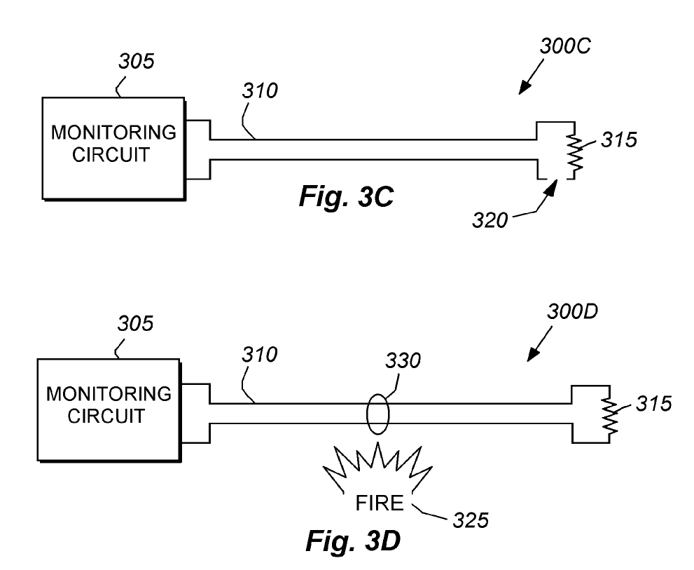

FIG. 3A is a schematic diagram of an exemplary linear heat detector environment 300A in accordance with an illustrative embodiment of the present invention. A monitoring circuit 305 is operatively interconnected to a length of the digital linear heat detector with thermal activation confirmation 310. A resistor 315 terminates the digital linear heat detector with thermal activation confirmation 310. Digital linear heat detector with thermal activation confirmation installations thus resemble digital linear heat detector installations; however, due to the construction of the digital linear heat detector with thermal activation confirmation, discussed further below, mechanical shorts will not cause ALARM conditions, thereby preventing spurious activation of fire suppression systems, etc.

In operation, the monitoring circuit 305 monitors the loop resistance along the digital linear heat detector with thermal activation confirmation 310, which is fixed by the terminating resistor 315. The monitoring circuit 305 is configured so that the fixed steady state resistance along the digital linear heat detector with thermal activation confirmation 310 results in a NORMAL state.

FIG. 3B is a schematic diagram of an exemplary linear heat detector environment 300B in accordance with an illustrative embodiment of the present invention. A monitoring circuit 305 is operatively interconnected to a length of the digital linear heat detector with thermal activation confirmation 310A, B. In exemplary environment 300B, at least a pair of linear heat detector conductors 310A, B loops back to the monitoring circuit 305 with no terminating resistor. Thus, in accordance with alternative embodiments of the present invention, the novel linear heat detector of the present invention may be resistor terminated (300A) or may form a complete loop back to the monitoring circuit (300B).

FIG. 3C is a schematic diagram of an exemplary digital linear heat detector with thermal activation confirmation environment 300C similar to that shown in environment 300A. However, in environment 300C, an open circuit in the linear heat detector has occurred at location 320. If an open circuit occurs, the loop resistance becomes infinite. The monitoring circuit 305 is configured to report an infinite resistance as an OPEN fault condition. This may cause the monitoring circuit 305 to, e.g., sound an alert to inform an administrator that there is an open circuit and that the overheat (e.g., fire) detection functionality has been compromised.

Illustratively, the digital linear heat detector with thermal activation confirmation 310 will not cause an ALARM condition should physical damage cause a short. Should a short occur due to physical damage, e.g., crimping, etc., the loop resistance will drop. The monitoring circuit 305 is illustratively configured to detect this drop in resistance and to report a SHORT fault condition. By utilizing the same techniques as described above with respect to digital linear heat detectors, the location of the short may be identified.

FIG. 3D is a schematic diagram of an exemplary digital linear heat detector with thermal activation confirmation environment 300D illustrating the detection of a fire or other significant heat source in accordance with an illustrative embodiment of the present invention. A fire 325 raises the temperature within a region 330 of the linear heat detector 310. As a result of the heat, the non-conductive polymer will melt, thereby causing the NTC coated conductors to be forced together by the spring pressure of the conductors. The resistance will decrease based on the temperature and the exposed cross section length. This change in resistance will be detected by the monitoring circuit 305 and result in an ALARM condition. Due to this negative change in resistance caused by heat, a physical fault in the heat sensitive insulation will not produce the same resistance a thermal fault thereby allowing the monitoring circuit to distinguish between thermal activation (i.e., a true alarm) and activation by physical damage (i.e., a false alarm). The monitoring circuit 305 may initiate fire suppression systems, etc., in response to the ALARM condition.

If the heat source is removed prior to the NTC polymer melting, the loop resistance will return to normal. This will effectively cancel the ALARM condition and reset the digital linear heat detector with thermal activation confirmation. Illustratively, the NTC coated conductors are still held together by the spring pressure; however, as the NTC resistance is sufficiently high at low temperatures, the monitoring circuit 305 will detect this as a NORMAL state.

Should the heat source, e.g., fire 325, continue to a sufficient length of time, the thermoplastic NTC material will melt, thereby causing a short circuit. The detection of the location of this short circuit may be made using the same techniques as described above with respect to digital linear heat detectors.

B. Digital Linear Heat Detector Operation

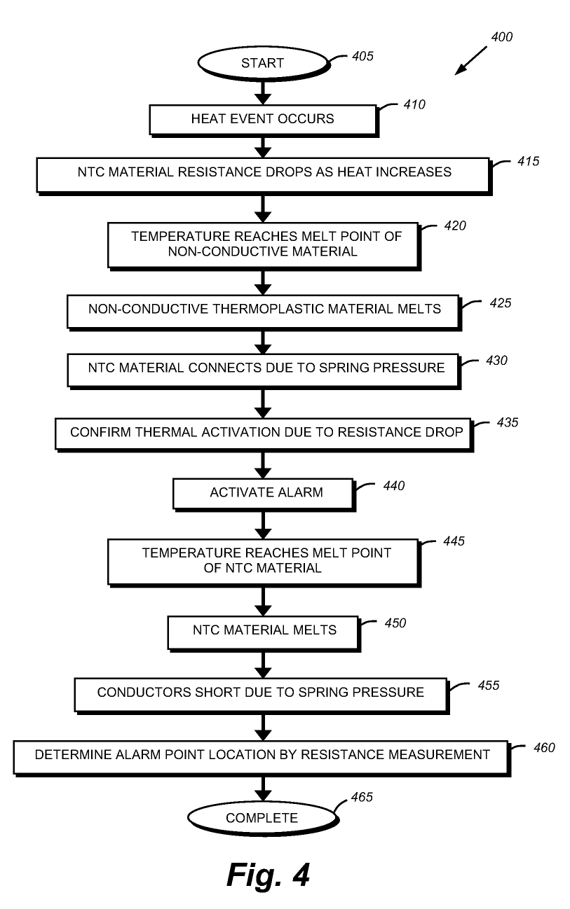

FIG. 4 is a flow chart detailing the steps of a procedure 400 identifying the steps of a overheat condition occurring in accordance with an illustrative embodiment of the present invention. As will be appreciated by one skilled in the art, the various steps of procedure 400 may occur on varying timescales based on the size and/or temperature of an overheat condition. That is, larger and/or hotter fires (or other overheat conditions) typically will cause procedure 400 to occur more rapidly, while lesser overheat conditions may cause procedure 400 to occur at a less rapid pace. Additionally, depending on the severity of the overheat condition, not all steps of procedure 400 may occur. As such, the description herein of procedure 400 should be taken as exemplary only.

Procedure 400 begins in step 405 and continues to step 410 where a heat event (e.g., a fire) occurs. As will be appreciated by one skilled in the art, other heat events other than fires may cause overheat conditions. As such, although this description is written in terms of a fire, one skilled in the art will recognize that other events may cause overheat conditions. As such, the description of a fire should be taken as exemplary only.

During the course of the heat event, the temperature of the NTC material will increase. In response, the NTC material's resistance drops as the heat increases in step 415. Eventually, the temperature reaches the melting point of the non-conductive material in step 420, which causes the non-conductive material to melt in step 425. As a result of the non-conductive material melting, the NTC material makes contact due to the spring pressure applied in step 430. At this point, there is a significant drop in resistance, which is utilized by the monitoring circuit to confirm that there is a thermal activation in step 435. Typically, this results in an ALARM state being activated in step 440.

Eventually, the temperature will reach the melting point of the thermoplastic NTC material in step 445. The thermoplastic NTC material then melts in step 450. At this point, the conductors themselves will come into contact due to the spring pressure in step 445. Once the conductors come into contact with each other, the monitoring circuit may determine the alarm point location by measuring the resistance along the digital linear heat detector of the present invention in step 460. As the conductors have a predefined and known resistance, e.g., 0.5 Ohms per foot, when two conductors come into physical contact with each other, the monitoring circuit may determine the total length of the digital linear heat detector between the monitoring circuit and the location of the short. This enables the location of the heat event to be determined. The procedure 400 then completes in step 465.

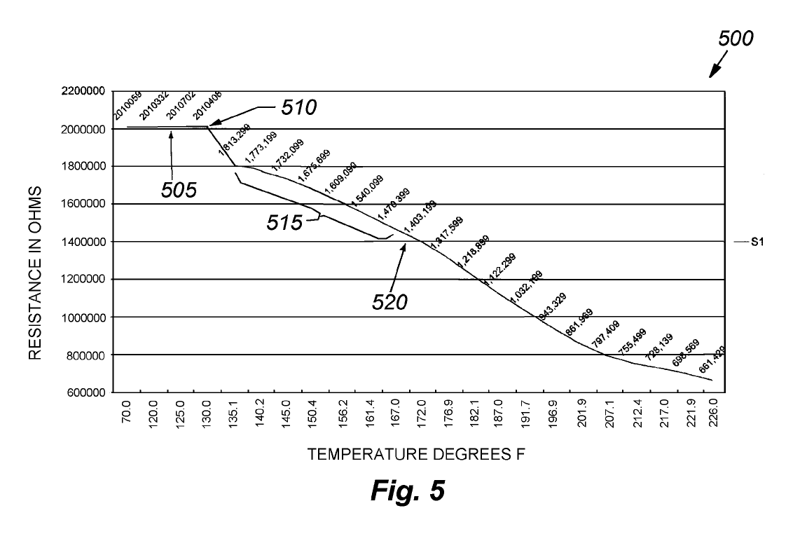

FIG. 5 is a graph 500 illustrating a resistance curve in accordance with an illustrative embodiment of the present invention. The X-axis is the temperature in Fahrenheit, while the Y-axis is resistance in ohms. At region 505 normal resistance is maintained as heat slowly reaches the melting point 510 of the non-conductive material. Once the melting point 510 of the non-conductive material is reached, the NTC coatings come into contact due to the spring pressure. Along region 515, the resistance will drop as the heat level increases until the melting point 520 of the thermoplastic NTC material. At that point resistance will continue to drop off as the spring conductors will make contact and a thermal activation is confirmed.

As will be appreciated by one skilled in the art, the use of an NTC material enables changes in resistance to occur based on heat, thereby providing better thermal activation confirmation capabilities. Similarly, should the temperature not reach the melting point 520 of the thermoplastic NTC material, resistance will increase back to point 510 where the thermoplastic insulation layer melted. Effectively, this enables the linear heat detector of the present invention to reset itself should a heat condition not reach a predefined threshold, i.e., the melt point of the thermoplastic NTC material.

C. Digital Linear Heat Detector Composition

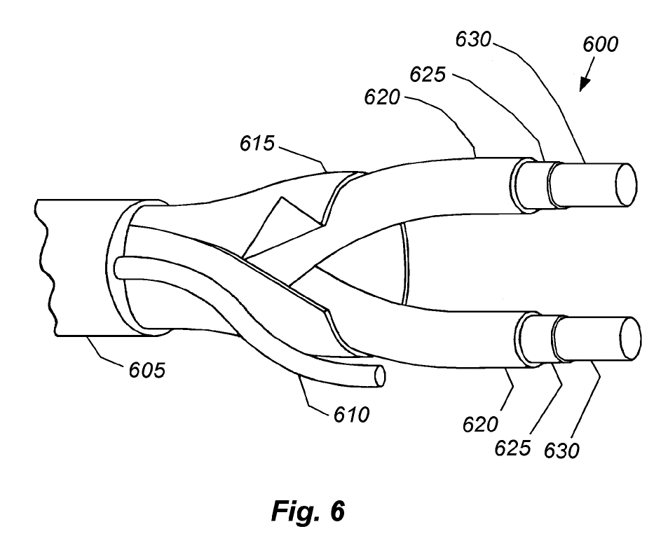

Various configurations of digital linear heat detectors with thermal activation confirmations may be utilized in accordance with various embodiments of the present invention. FIGS. 6-12 describe various illustrative embodiments of the present invention.

FIG. 6 is a schematic diagram of an exemplary cross-section of a digital linear heat detector with thermal activation confirmation 600 in accordance with an illustrative embodiment of the present invention. The digital linear heat detector with thermal activation confirmation 600 comprises an outer jacket 605. Illustratively, the outer jacket 605 may comprise an extruded covering that is comprised of polyvinyl chloride available from Sylvin Technologies. An optional drain wire 610 may be incorporated into the digital linear heat detector 600. A protective tape and/or shield 615 is utilized to cover the twisted conductors. Illustratively, a protective tape 615 may comprise a Mylar® tape. However, it should be noted that in alternative embodiments, additional and/or differing materials may be utilized, e.g., polypropylene. As such, the description of a Mylar® tape should be taken as exemplary only. Within the protective tape 615 the digital linear heat detector with thermal activation confirmation illustratively comprises of three layers. An inner spring conductor 630 is encased with a conductive NTC material 625, which is then coated with a non-conductive heat sensitive material 620. In an illustrative embodiment, the spring conductors 630 comprise of 0.035 inch diameter galvanized spring steel. However, it should be noted that in alternative embodiments the diameter and/or composition of the inner conductors 630 may vary. As such, the description of the use of galvanized spring steel and the specific diameters should be taken as exemplary only. The NTC material 625 is illustratively conductive PVC available from Sylvin Technologies. The non-conductive heat sensitive material 620 is illustrative ethyl vinyl acetate available from Dupont. However, it should be noted that both the NTC material 625 and/or the non-conductive heat sensitive material may be made of different compositions in alternative embodiments of the present invention. As such, the description herein should be taken as exemplary only.

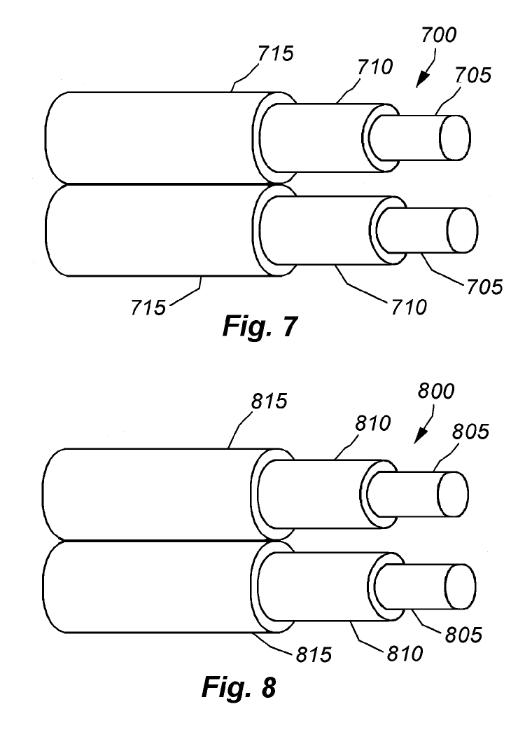

FIG. 7 is a schematic diagram of an exemplary cross-section of a digital linear heat detector with thermal activation confirmation 700 in accordance with an illustrative embodiment of the present invention. The illustrative digital linear heat detector with thermal activation confirmation 700 comprises a spring conductor core 705 that is coated with NTC material 710. Overlaid onto the NTC 710 is a non-conductive heat sensitive material layer 715.

FIG. 8 is a schematic diagram of an exemplary cross-section of digital linear heat detector with thermal activation confirmation 800 in accordance with an illustrative embodiment of the present invention. The illustrative digital linear heat detector with thermal activation confirmation 800 comprises a spring conductor 805 that is first coated with a non-conductive heat sensitive material 810. The non-conductive heat sensitive material 810is then coated with a NTC material 815. As will be appreciated by one skilled in the art, the outer two layers have been swapped between digital linear heat detector with thermal activation confirmation 700 and digital linear heat detector with thermal activation confirmation 800.

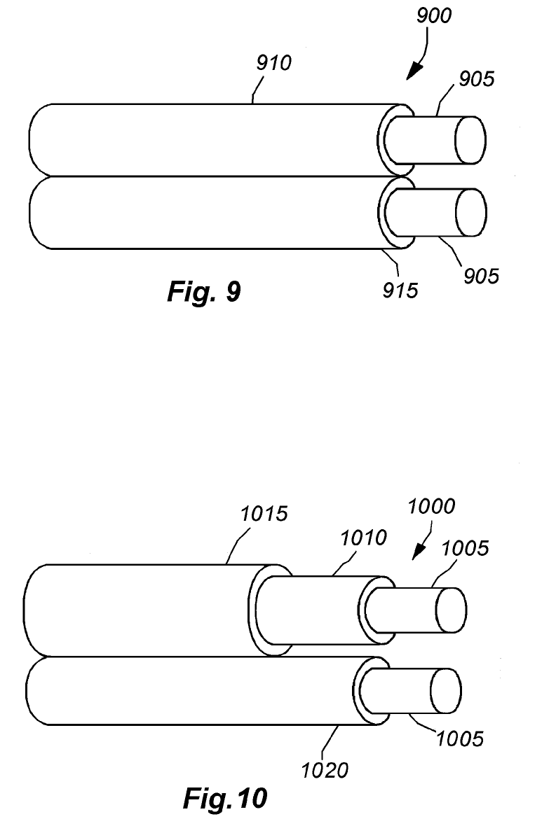

FIG. 9 is a schematic diagram of an exemplary cross-section of a digital linear heat detector with thermal activation confirmation 900 in accordance with an illustrative embodiment of the present invention. Digital linear heat detector with thermal activation confirmation 900 includes two spring conductors 905. However, one of the spring conductors 905 is coated with a non-conductive heat sensitive material 910, while the other conductor 905 is coated with a NTC material 915.

FIG. 10 is a schematic diagram of an exemplary cross-section of a digital linear heat detector with thermal activation confirmation 1000 in accordance with an illustrative embodiment of the present invention. The digital linear heat detector with thermal activation confirmation 1000 comprises two central spring conductor 1005. One of the spring conductors 1005 is coated by a NTC material layer 1010 and a non-conductive heat sensitive material 1015. The second spring conduct 1005 is only coated with a NTC material 1020.

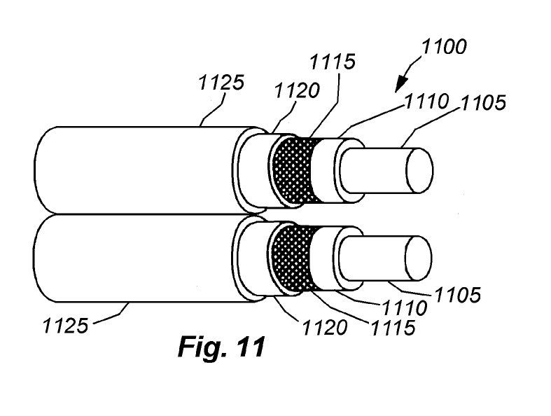

FIG. 11 is a schematic diagram of an exemplary cross-section of a digital linear heat detector with thermal activation confirmation 1100 in accordance with an illustrative embodiment of the present invention. The digital linear heat detector with thermal activation confirmation 1100 includes a central spring conductor 1105. Encircling the spring conductor 1105 is a layer of NTC material 1110. A high-melt temperature non-conductive braid 1115 encases the NTC material 1110. Illustratively the non-conductive braid 1115 is impregnated with NTC material. A further layer of NTC material encircles the braid layer 1120. Finally, a non-conductive heat sensitive material 1125 is utilized.

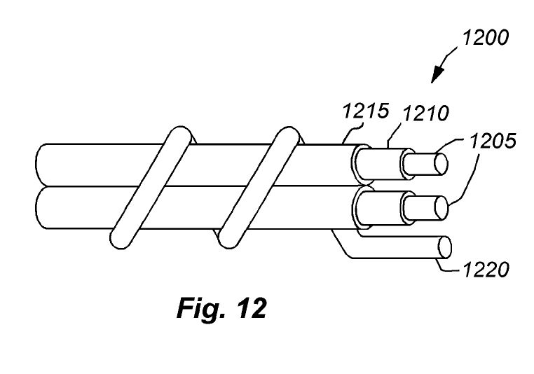

FIG. 12 is a schematic diagram of an exemplary cross-section of a digital linear heat detector with thermal activation confirmation 1200. The digital linear heat detector 1200 includes a central pair of conductors 1205 that are coated by a layer of NTC material 1210. A heat sensitive thermoplastic is layered onto the NTC material. A spring conductor 1220 is then wrapped around the coated pair. Due to the central conductors 1205 not being twisted together, the chance of a short between them is minimized.

As will be appreciated by one skilled in the art, the various compositions of digital linear heat detector with thermal activation confirmations described above with reference to FIGS. 6-12 exemplary only. Additional variations of layers of NTC material, non-conductive heat sensitive material, high-melt temperature braids, etc. may be made without departing from the spirit or scope of the present invention. Furthermore, it is expressly contemplated that the various compositions of the NTC material and/or the non-conductive heat sensitive material may vary from that described herein. As such, the descriptions of specific materials and/or properties should be taken as exemplary only.

What is claimed is:

1. A digital linear heat detector with thermal activation confirmation comprising:
a first conductor and a second conductor, the first and second conductors each coated with an inner layer of a negative temperature coefficient material and an outer layer of a non-conductive heat sensitive material;
wherein a substantially continuous spring pressure between the first conductor and the second conductor is provided to cause the layers of the non-conductive heat sensitive material to be in contact;
a monitoring circuit configured to monitor resistance along the first and second conductors;
wherein, in response to a heat event reaching a first predefined temperature, the layers of the non-conductive temperature sensitive material melts, thereby causing the layers of negative temperature coefficient material to come into contact; and
wherein the monitoring circuit can detect the change in resistance due to changes in resistance of the negative temperature coefficient material caused by variations in temperature.

2. The digital linear heat detector of claim 1 wherein the negative temperature resistance material comprises conductive PVC.

3. The digital linear heat detector of claim 1 wherein, in response to the heat event reaching a second predefined temperature, the negative temperature coefficient material melts, thereby causing the first and second conductors to come into direct contact.

4. The digital linear heat detector of claim 3 wherein the monitoring circuit detects a change in resistance along the first and second conductors caused by the first and second conductors coming into direct contact.

5. The digital linear heat detector of claim 1 wherein the first and second conductors comprise galvanized spring steel.

6. The digital linear heat detector of claim 1 wherein the non-conductive temperature sensitive material comprises ethyl vinyl acetate.

7. The digital linear heat detector of claim 1 wherein, in response to the resistance reaching a predefined level, the monitoring circuit initiates an alarm state.

8. The digital linear heat detector of claim 7 wherein the predefined level comprises a resistance indicative of a specific cross section of digital linear heat detector being exposed to a predefined alarm temperature.

9. A digital linear heat detector with thermal activation confirmation comprising:
a first conductor coated with at least a layer of a negative temperature coefficient material;
a second conductor coated with at least a layer of a non-conductive heat sensitive material;
a monitoring circuit configured to monitor resistance along the first and second conductors;
wherein, in response to a heat event reaching a first predefined temperature, the layer of the non-conductive temperature sensitive material melts, thereby causing the layer of negative temperature coefficient material to come into contact with the second conductor; and
wherein the monitoring circuit can detect the change in resistance along the first and second conductors due to changes in resistance of the negative temperature coefficient material caused by variations in temperature.

10. A digital linear heat detector with thermal activation confirmation comprising:
a first conductor coated with an inner layer of a negative temperature coefficient material and an outer layer of a non-conductive heat resistance material;
a second conductor coated with an inner layer of a negative temperature coefficient material and an outer layer of a non-conductive heat resistance material;
a spring conductor wrapped around the first and second conductors to maintain a substantially continuous spring pressure between the first and second conductors;
a monitoring circuit configured to monitor resistance along the first and second conductors;
wherein, in response to a heat event reaching a first predefined temperature, the layers of the non-conductive temperature sensitive material melts, thereby causing the layers of negative temperature coefficient material to come into contact with each other; and
wherein the monitoring circuit can detect the change in resistance along the first and second conductors due to changes in resistance of the layers of negative temperature coefficient material caused by variations in temperature.

11. A digital linear heat detector with thermal activation confirmation comprising:
a monitoring circuit configured to measure changes in resistance along first conductor and a second conductor coated with at least a negative temperature sensitive material, wherein as a temperature increases, the resistance of the negative coefficient material decreases; and
wherein the monitoring circuit may cancel an alarm condition in response to the resistance increasing to a sufficient point due to the temperature decreasing below a predefined temperature.

12. The digital linear heat detector of claim 11 further comprising a substantially continuous spring pressure between the first conductor and the second conductor.

13. The digital linear heat detector of claim 12 wherein the substantially continuous spring pressure is caused by a spring conductor wrapped around the first and second conductors.

14. The digital linear heat detector of claim 11 wherein the monitoring circuit confirms a thermal event activation in response to a change in resistance indicative of a specific cross section of digital linear heat detector being exposed to a predefined alarm temperature.

15. The digital linear heat detector of claim 11 wherein the negative temperature sensitive material comprises conductive PVC.

16. The digital linear heat detector of claim 11 wherein the first and second conductors comprise galvanized spring steel.

17. The digital linear heat detector of claim 11 wherein at least one of the first and second conductors is coated with a non-conductive temperature sensitive material.

18. The digital linear heat detector of claim 17 wherein the non-conductive temperature sensitive material comprises ethyl vinyl acetate.

19. A method for operating digital linear heat detector comprising:
monitoring resistance along a first and second conductor of the digital linear heat detector;
detecting, in response to a non-conductive material melting due to a heat event reaching a first predefined temperature, a change in resistance caused by a layer of negative temperature coefficient material covering the first conductor coming into contact with a layer of negative temperature coefficient material covering the second conductor;
setting, in response to the detected change in resistance, an alarm state; and
detecting additional changes in resistance due to changes in resistance of the layer of negative temperature coefficient material covering the first conductor and the layer of negative temperature coefficient material covering the second conductor due to changes in temperature.

20. The method of claim 19 further comprising detecting a change in resistance due to the first conductor coming into contact with the second conductor due to the heat event reaching a second predefined temperature causing the negative temperature coefficient material to melt.

21. The method of claim 20 further comprising identifying a location of a heat event along the first and second conductors.

22. The method of claim 21 wherein the identifying comprises measuring a measured resistance compared to a predefined resistance associated with the first and second conductors.
